(19) United States
(12) Patent Application Publication
(10) Pub. No.: US 2006/0162332 A1
(43) Pub. Date: Jul. 27, 2006

(54) Reducing power to a shape memory alloy background

(76) Inventors: David Klaffenbach, Battle Ground, WA (US); Anthony Carcia, Partland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/040,905

(22) Filed: Jan. 21, 2005

(51) Int. Cl. F01B 29/10; F02G 1/04

(52) U.S. Cl. 60/527

(57) ABSTRACT

An embodiment of a method includes determining when a shape memory alloy completes changing shape based on measurements of a resistance of the shape memory alloy and reducing power supplied to the shape memory alloy after determining when the shape memory alloy completes changing shape.

Shape memory alloys (or SMAs) are alloys that can exist in two different solid phases at different temperatures. Shape memory alloys typically can change shape upon heating above a solid-solid phase-transition temperature and to return to a certain alternate shape upon cooling. This property makes many shape memory alloys suitable for use as actuators. For many applications, heating and cooling of shape memory alloys depend on ambient conditions. This can lead to difficulties for applications where a shape memory alloy will be exposed to a variety of ambient conditions.

### DESCRIPTION OF THE DRAWINGS

FIG. 1 is a block diagram of an embodiment of an actuator system, according to an embodiment of the present disclosure.

FIG. 2 is an embodiment of an actuator, according to another embodiment of the present disclosure.

FIG. 3 is an exemplary resistance versus temperature curve of an embodiment of an actuator, according to another embodiment of the present disclosure.

### DETAILED DESCRIPTION

In the following detailed description of the present embodiments, reference is made to the accompanying drawings that form a part hereof, and in which is shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

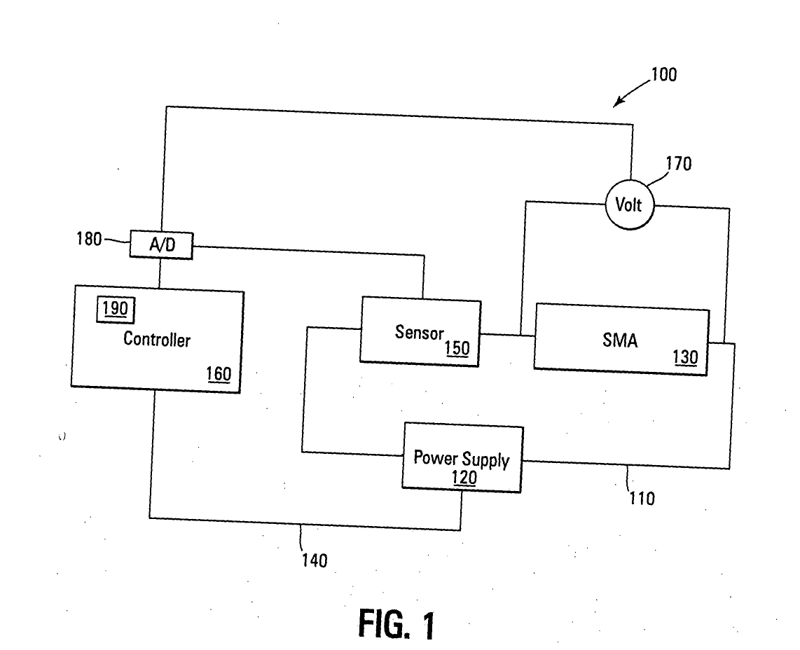

FIG. 1 is a block diagram of an actuator system 100, according to an embodiment. For one embodiment, system 100 includes a power loop 110 that includes a power supply 120 electrically connected to a shape memory alloy actuator 130. System 100 also includes a control loop 140 that includes a current sensor 150 electrically connected in power loop 110 between power supply 120 and shape memory alloy actuator 130. For one embodiment, a controller 160 of control loop 140 is electrically connected between current sensor 150 and power supply 120. Power supply 120 may be a constant-current or a constant-voltage power supply or a power supply that can operate in constant-current or constant-voltage mode to provide, respectively, substantially constant current over a range of voltage or substantially constant voltage over a range of current. For one embodiment, the current and/or voltage supplied by power supply 120 can be varied. For another embodiment, a voltage sensor 170 may be connected across shape memory alloy actuator 130. For some embodiments, an analog-to-digital (A/D) converter 180 is included in control loop 140 between current sensor 150 and/or voltage sensor 170. For other embodiments, A/D converter 180, current sensor 150, and/or voltage sensor 170 are integral portions of controller 160. Note that A/D converter 180 converts analog signals received thereat from current sensor 150 and/or voltage sensor 170, converts them to digital signals, and transmits to controller 160.

For another embodiment, controller 160 is adapted to perform methods in accordance with embodiments of the present disclosure in response to computer-readable instructions. These computer-readable instructions are stored on a computer-usable media 190 of controller 160 and may be in the form of software, firmware, or hardware. In a hardware solution, the instructions are hard coded as part of a processor, e.g., an application-specific integrated circuit (ASIC) chip. In a software or firmware solution, the instructions are stored for retrieval by controller 160. Some additional examples of computer-usable media include static or dynamic random access memory (SRAM or DRAM), read-only memory (ROM), electrically-erasable programmable ROM (EEPROM or flash memory), magnetic media and optical media, whether permanent or removable. Many consumer-oriented computer applications are software solutions provided to the user on some removable computer-usable media, such as a compact disc read-only memory (CD-ROM).

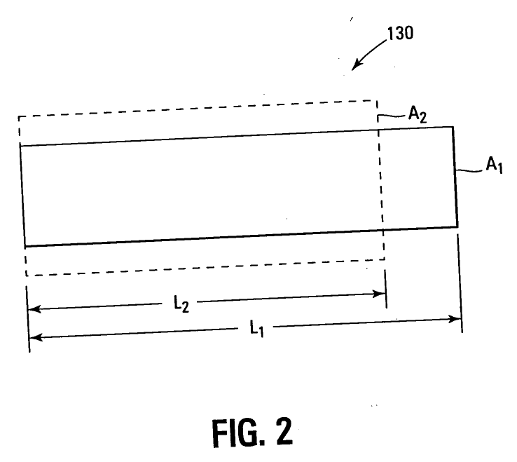

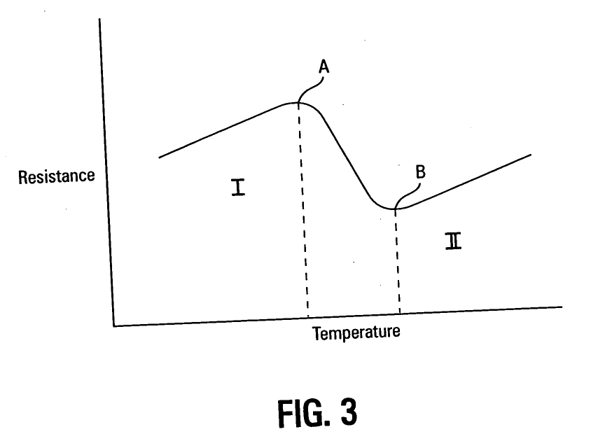

For one embodiment, shape memory alloy actuator 130 is a wire or a block, as shown in FIG. 2, e.g., of a nickel titanium alloy, such as Nitinol (Nickel-Titanium Naval Ordnance Laboratory). FIG. 3 shows that when shape memory alloy actuator 130 is heated while in a first solid phase (solid phase I), its resistance increases as its temperature increases until point A of FIG. 3, and its shape remains substantially unchanged. When the temperature is increased past a solid-solid phase-transition temperature of shape memory alloy actuator 130, shape memory alloy actuator 130 changes shape when it changes from the first solid phase to a second solid phase (solid phase II). For one embodiment, the change in shape is characterized by a decrease in length L and an increase in the cross-sectional area A of shape memory alloy actuator 130, as shown in FIG. 2. The decrease in length and the increase in cross-sectional area act to reduce the resistance of shape memory alloy actuator 130. Further increases in temperature cause the resistance of shape memory alloy actuator 130 to increase while in its second solid phase, i.e., after point B of FIG. 3, while the shape remains substantially unchanged.

In operation, control loop 140 determines the electrical resistance of shape memory alloy actuator 130 as it is heated by dissipating current supplied thereto by power supply 120. Controller 160 monitors the resistance during heating. After the resistance starts to decrease, as a result of the phase transition and associated change in shape of shape memory alloy actuator 130, and subsequently just starts to increase, signaling that the change in shape is complete, controller 160 sends a signal to power supply 120 instructing it to stop supplying power to shape memory alloy actuator 130. Use of the term “complete” in the specification with reference to the degree to which a change in shape of the shape memory alloy has occurred includes a degree of change such that change in shape of the shape memory alloy is at least substantially complete. The precision with which the time when the resistance of shape memory alloy just begins to increase can be determined will affect the range within which the determination of the time when the change in shape is substantially complete will be of the time when the change in shape is fully complete. And, the uncertainty associated with determining when the resistance of shape memory alloy, such as in shape memory alloy actuator 130, just begins to increase will be affected by the measurement tolerances associated with techniques and/or hardware selected for performing the resistance measurement, such as for controller 160, voltage sensor 170, analog-digital converter 180, power supply 120, and current sensor 150. That is, when a slope of a curve of the resistance of shape memory alloy actuator 130 versus the temperature of shape memory alloy actuator 130 (or the heating time) transitions from negative to positive (i.e., at about point B of FIG. 3), controller 160 instructs power supply to stop heating shape memory alloy actuator 130, e.g., by stopping the flow of current to the shape memory alloy actuator 130. This acts to adjust the heating time according to changing ambient conditions and thus acts to reduce the likelihood that shape memory alloy actuator 130 will be over or under heated as a result of changing ambient conditions that could occur when the heating time is fixed.

For other embodiments, controller 160 instructs power supply to reduce heating shape memory alloy actuator 130, e.g., by reducing the flow of current to the shape memory alloy actuator 130 to a level where the resistance of shape memory alloy actuator 130 is maintained at about that of point B. For some embodiments, the controller 160 can maintain shape memory alloy actuator 130 alternately in one of two states. In a first state, the actuator 130 is be maintained at about point A, e.g., at about the highest temperature in FIG. 3 at which shape memory alloy actuator 130 is still elongated. That is, where the slope of the curve of the resistance of shape memory alloy actuator 130 versus the temperature of shape memory alloy actuator 130 transitions from positive to negative. In a second state, shape memory alloy actuator 130 is maintained at about point B, e.g., at about the lowest temperature in FIG. 3 at which shape memory alloy actuator 130 is contracted. Maintaining the actuator at point A or B acts to reduce the time used to change to the other state. Note that the power supplied to shape memory alloy actuator 130, and thus the amount of heat, is increased to change from phase I to phase II and to activate shape memory alloy actuator 130. Note further that the amount of power (or heat) used to maintain shape memory alloy actuator 130 at point A is less than that used to maintain shape memory alloy actuator 130 at point B.

For one embodiment, the resistance of shape memory alloy actuator 130 is measured by measuring the current flow through power loop 110 using current sensor 150 and the voltage drop across shape memory alloy actuator 130 using voltage sensor 170 and subsequently applying Ohms Law to compute the resistance from the measured current and voltage drop. This enables the resistance to be computed at a plurality of times during heating of shape memory alloy actuator 130. For another embodiment, where power supply 120 is a constant-current power supply, the current is set and may be input into controller 160 by a user. For this embodiment, current sensor 150 would not be used, since the voltage drop from voltage sensor 170 can be used with the set value of the current to determine the resistance. For other embodiments, controller 160 may used to set a current or voltage output of power supply 120 via user inputs.

For some embodiments, where power supply 120 is a constant-voltage power supply, the voltage is set and may be input into controller 160 by a user. For these embodiments, voltage sensor 170 would not be used, since the current flow from current sensor 150 can be used with the set value of the voltage to determine the resistance. Note that this may involve an accounting of other resistances in power loop 110 or may presuppose that these resistances are negligible compared to the resistance of shape memory alloy actuator 130.

For one embodiment, current sensor 150 may be a calibrated sense resistor having a predetermined resistance value connected in series with shape memory alloy actuator 130, and the current through current sensor 150 and thus through power loop 110 is determined by measuring a voltage drop across the sense resistor and using Ohms law with the measured voltage drop and the predetermined resistance value.

For other embodiments, failure of shape memory alloy actuator 130, e.g., a break in shape memory alloy actuator 130, may be detected by there being no current through power loop 110 or an effectively infinite resistance determined across shape memory alloy actuator 130.

### CONCLUSION

Although specific embodiments have been illustrated and described herein it is manifestly intended that the scope of the claimed subject matter be limited only by the following claims and equivalents thereof.

What is claimed is:

1. A method, comprising:
determining when a shape memory alloy completes changing shape based on measurements of a resistance of the shape memory alloy; and
reducing power supplied to the shape memory alloy after the determining.

2. The method of claim 1, wherein determining the resistance of the shape memory alloy comprises measuring at least one of a current flowing through the shape memory alloy and a voltage drop across the shape memory alloy.

3. The method of claim 1, wherein determining when the shape memory alloy completes changing shape based on measurements of a resistance of the shape memory alloy comprises determining when the resistance of the shape memory alloy starts increasing after decreasing.

4. The method of claim 1, wherein reducing the power supplied to the shape memory alloy comprises reducing the power to a level that maintains the shape memory alloy where the changing shape is complete.

5. The method of claim 1 further comprises before determining when the shape memory alloy completes changing shape, maintaining the power at a level where the resistance of the shape memory alloy has decreased after increasing.

6. The method of claim 1, wherein reducing the power supplied to the shape memory alloy further comprises stopping the power supplied to the shape memory alloy.

7. A method, comprising:
determining when a resistance of a shape memory alloy begins increasing after decreasing while heating the shape memory alloy; and
reducing the heating of the shape memory alloy when the resistance begins increasing after decreasing.

8. The method of claim 7 further comprises measuring the resistance of the shape memory alloy.

9. The method of claim 8, wherein measuring the resistance of the shape memory alloy comprises measuring at least one of a current flowing through the shape memory alloy and a voltage drop across the shape memory alloy.

10. The method of claim 7, wherein reducing heating of the shape memory alloy comprises reducing the heating to a level that maintains the resistance where the shape memory alloy completes changing shape.

11. The method of claim 7, wherein reducing heating of the shape memory alloy further comprises stopping the power supplied to the shape memory alloy.

12. A method of operating a shape memory alloy actuator, comprising:
causing an electric current to flow in the shape memory alloy actuator;
determining a resistance of the shape memory alloy actuator during flow of the electric current; and
reducing the current flow when the resistance of the shape memory alloy actuator indicates that the shape memory alloy actuator completes changing shape.

13. The method of claim 12, wherein the flow of the electric current causes heating of the shape memory alloy actuator for causing the shape memory alloy actuator to change shape.

14. The method of claim 12, wherein determining the resistance of the shape memory alloy actuator comprises measuring at least one of a current flowing through the shape memory alloy actuator and a voltage drop across the of the shape memory alloy actuator.

15. The method of claim 12, wherein the resistance of the shape memory alloy actuator indicates that the shape of the shape memory alloy actuator completes changing with heating when the resistance starts increasing with heating of the shape memory alloy actuator after decreasing with heating of the shape memory alloy actuator.

16. The method of claim 12, wherein reducing the current flow when the resistance of the shape memory alloy actuator indicates that the shape of the shape memory alloy actuator completes changing with heating of the shape memory alloy actuator comprises reducing the current flow to a level that maintains the resistance where the shape memory alloy actuator completes changing shape.

17. The method of claim 12, wherein reducing the current flow when the resistance of the shape memory alloy actuator indicates that the shape of the shape memory alloy actuator completes changing with heating of the shape memory alloy actuator further comprises stopping the current flow.

18. The method of claim 12, wherein causing an electric current to flow in the shape memory alloy actuator comprises supplying a first level of current flow to the shape memory alloy actuator, and further comprising before supplying the first level of current flow, supplying a second level of current flow to the shape memory alloy actuator, that is less than the first level of current flow, to maintain the resistance of shape memory alloy actuator at a point where the shape memory alloy actuator is about to start changing shape.

19. A method of controlling a shape memory alloy actuator, comprising:
receiving a first signal at a controller indicative of a current flowing through the shape memory alloy actuator;
determining a resistance of the shape memory alloy actuator at the controller based on a voltage supplied to the shape memory alloy actuator by a power supply and the current; and
sending a second signal to the power supply from the controller for instructing the power supply to reduce the current flowing through the shape memory alloy actuator when the resistance indicates that the shape of the shape memory alloy actuator completes changing.

20. The method of claim 19, wherein determining a resistance of the shape memory alloy actuator is for determining a change in shape of the shape memory alloy actuator as the current is flowing through the shape memory alloy actuator.

21. The method of claim 19 further comprises converting the first signal from an analog to a digital signal before it is received at the controller.

22. The method of claim 19, wherein the power-supply is a constant-voltage power-supply.

23. The method of claim 19, wherein the first signal is a voltage drop across a resistor connected in series with the shape memory alloy actuator, wherein the voltage drop across the resistor is related to the current by a resistance of the resistor.

24. The method of claim 19, wherein the resistance of the shape memory alloy actuator indicates that the shape of the shape memory alloy actuator completes changing when the resistance starts increasing after decreasing as the current flows through the shape memory alloy actuator.

25. The method of claim 19, wherein the power is reduced to a level that maintains the resistance where the shape memory alloy actuator completes changing shape.

26. The method of claim 19, wherein instructing the power supply to reduce the current flowing through the shape memory alloy actuator further comprises instructing the power supply to stop the current flowing through the shape memory alloy actuator.

27. A method of controlling a shape memory alloy actuator, comprising:
receiving a first signal at a controller indicative of a voltage drop across the shape memory alloy actuator in response to current flowing through the shape memory alloy actuator;
determining a resistance of the shape memory alloy actuator at the controller based on the voltage drop across the shape memory alloy actuator and the current; and
sending a second signal to the power supply from the controller for instructing the power supply to reduce power supplied to the shape memory alloy actuator when the resistance indicates that the shape of the shape memory alloy actuator completes changing.

28. The method of claim 27, wherein determining a resistance of the shape memory alloy actuator is for determining a change in shape of the shape memory alloy actuator as the current is flowing through the shape memory alloy actuator.

29. The method of claim 27, wherein instructing the power supply to reduce power supplied to the shape memory alloy actuator further comprises instructing the power supply to stop the power supplied to the shape memory alloy actuator.

30. The method of claim 27, wherein the resistance of the shape memory alloy actuator indicates that the shape of the shape memory alloy actuator completes changing when the resistance starts increasing after decreasing as the current flows through the shape memory alloy actuator.

31. The method of claim 27 further comprises converting the first signal from an analog to a digital signal before it is received at the controller.

32. The method of claim 27, wherein the power-supply is a constant-current power-supply.

33. The method of claim 27, wherein the power is reduced to a level that maintains the resistance where the shape memory alloy actuator completes changing shape.

34. A method of controlling a shape memory alloy actuator, comprising:
receiving a first signal at a controller indicative of a current flowing through the shape memory alloy actuator;
receiving a second signal at a controller indicative of a voltage drop across the shape memory alloy actuator;
determining a resistance of the shape memory alloy actuator at the controller based on the voltage drop across the shape memory alloy actuator and the current; and
sending a third signal to the power supply from the controller for instructing the power supply to reduce power supplied to the shape memory alloy actuator when the resistance indicates that the shape of the shape memory alloy actuator completes changing.

35. The method of claim 34, wherein determining a resistance of the shape memory alloy actuator is for determining a change in shape of the shape memory alloy actuator as the current is flowing through the shape memory alloy actuator.

36. The method of claim 34, wherein instructing the power supply to reduce power supplied to the shape memory alloy actuator further comprises instructing the power supply to stop the power supplied to the shape memory alloy actuator.

37. The method of claim 34, wherein the resistance of the shape memory alloy actuator indicates that the shape of the shape memory alloy actuator completes changing when the resistance starts increasing after decreasing as the current flows through the shape memory alloy actuator.

38. The method of claim 34 further comprises converting the first and second signals from analog to digital signals before they are received at the controller.

39. The method of claim 34, wherein the first signal is a voltage drop across a resistor connected in series with the shape memory alloy actuator, wherein the voltage drop across the resistor is related to the current by a resistance of the resistor.

40. The method of claim 34, wherein the power-supply is either constant-current or a constant-voltage power supply.

41. The method of claim 34, wherein the power is reduced to a level that maintains the resistance where the shape memory alloy actuator completes changing shape.

42. A control system for controlling a shape memory alloy actuator, comprising:
a controller connectable to a loop containing the shape memory alloy actuator and to a power supply disposed in the loop for supplying power to the shape memory alloy actuator;
wherein the controller is adapted to determine when the shape memory alloy actuator completes changing shape based on a resistance of the shape memory alloy actuator determined from signals from the loop; and
wherein the controller is adapted to instruct the power supply to reduce power supplied to the shape memory alloy actuator when the resistance indicates that the shape of the shape memory alloy actuator completes changing.

43. The control system of claim 42, wherein to reduce power supplied to the shape memory alloy actuator further comprises to stop the power supplied to the shape memory alloy actuator.

44. The control system of claim 42 further comprises at least one of a current sensor connected to the controller and connectable to the loop and a voltage sensor connected the controller and connectable to the loop across the shape memory alloy actuator.

45. The control system of claim 42 further comprises an analog-to-digital converter connected to the controller and connectable to the loop.

46. The control system of claim 42, wherein the resistance of the shape memory alloy actuator indicates that the shape of the shape memory alloy actuator completes changing when the resistance starts increasing after decreasing as the power is supplied to the shape memory alloy actuator.

47. The control system of claim 42, wherein the controller is further adapted to maintain the reduced power at a level where the resistance is at about where the shape memory alloy actuator completes changing shape.

48. The control system of claim 42, wherein the controller is further adapted to determine when the shape memory alloy actuator is about to start changing shape based on the resistance of the shape memory alloy actuator determined from the signals from the loop as power is supplied to the shape memory alloy actuator, and wherein the controller is further adapted to instruct the power supply to supply enough power to maintain the resistance of the shape memory alloy actuator at a level where the shape memory alloy actuator is about to start changing shape.

49. A control system for controlling a shape memory alloy actuator, comprising:
at least one of a current sensor connectable between a power supply and the shape memory alloy actuator and a voltage sensor connectable across the shape memory alloy actuator; and
a controller connectable to the power supply and connected to the at least one of the current sensor and the voltage sensor;
wherein the controller is adapted to receive a signal from the at least one of the current sensor and the voltage sensor;
wherein the controller is adapted to determine a resistance of the shape memory alloy actuator based on the signal from the at least one of the current sensor and the voltage sensor for determining a change in shape of the shape memory alloy actuator as power is supplied to the shape memory alloy actuator from the power supply; and
wherein the controller is adapted to send a signal to the power supply for instructing the power supply to reduce power supplied to the shape memory alloy actuator when the resistance indicates that the shape of the shape memory alloy actuator completes changing.

50. The control system of claim 49, wherein instructing the power supply to reduce power supplied to the shape memory alloy actuator further comprises instructing the power supply to stop the power supplied to the shape memory alloy actuator.

51. The control system of claim 49 further comprises an analog-to-digital converter connected between the at least one of the current sensor and the voltage sensor and the controller.

52. The control system of claim 49, wherein the current sensor comprises a resistor, wherein current sensed thereby is based on a voltage drop across the resistor.

53. The control system of claim 49, wherein the resistance of the shape memory alloy actuator indicates that the shape of the shape memory alloy actuator completes changing when the resistance starts increasing after decreasing as the power is supplied to the shape memory alloy actuator.

54. The control system of claim 49, wherein the controller is further adapted to maintain the reduced power at a level where the resistance is where the shape memory alloy actuator completes changing shape.

55. An actuator system, comprising:
a loop comprising a power supply connected to a shape memory alloy actuator; and
a controller connected to the loop and the power supply;
wherein the controller is adapted to determine when the shape memory alloy actuator completes changing shape based on a resistance of the shape memory alloy actuator determined from signals from the loop; and
wherein the controller is adapted to instruct the power supply to reduce power supplied to the shape memory alloy actuator when the determined resistance indicates that the shape of the shape memory alloy actuator completes changing.

56. The actuator system of claim 55, wherein to reduce power supplied to the shape memory alloy actuator further comprises to stop the power supplied to the shape memory alloy actuator.

57. The actuator system of claim 55 further comprises at least one of a current sensor connected between the loop and the controller and a voltage sensor connected to the controller and to the loop across the shape memory alloy actuator.

58. The actuator system of claim 55 further comprises an analog-to-digital converter connected between the between the loop and the controller.

59. The actuator system of claim 55, wherein the resistance of the shape memory alloy actuator indicates that the shape of the shape memory alloy actuator completes changing when the resistance starts increasing after decreasing as the power is supplied to the shape memory alloy actuator.

60. The actuator system of claim 55, wherein the controller is further adapted to maintain the reduced power at a level where the resistance is at about where the shape memory alloy actuator completes changing shape.

61. The actuator system of claim 55, wherein the controller is further adapted to determine when the shape memory alloy actuator is about to start changing shape based on the resistance of the shape memory alloy actuator determined from the signals from the loop as power is supplied to the shape memory alloy actuator, and wherein the controller is further adapted to instruct the power supply to supply enough power to maintain the resistance of the shape memory alloy actuator at a level where the shape memory alloy actuator is about to start changing shape.

62. A system comprising:
a shape memory alloy actuator;
a power supply connected to the shape memory alloy actuator;
at least one of a current sensor connected between the power supply and the shape memory alloy actuator and a voltage sensor connected across the shape memory alloy actuator; and
a controller connected to the power supply and connected to the at least one of the current sensor and the voltage sensor;
wherein the controller is adapted to receive a signal from the at least one of the current sensor and the voltage sensor; and
the controller is adapted to determine a resistance of the shape memory alloy actuator based on the signal from the at least one of the current sensor and the voltage sensor; and
the controller is adapted to send a signal to the power supply to reduce power to the shape memory alloy actuator when the resistance indicates that the shape of the shape memory alloy actuator completes changing.

63. The system of claim 62, wherein determining a resistance of the shape memory alloy is for determining a change in shape of the shape memory alloy actuator as power is supplied thereto from the power supply.

64. The system of claim 62, wherein to reduce power to the shape memory alloy actuator further comprises to stop the power supplied to the shape memory alloy actuator.

65. The system of claim 62 further comprises an analog-to-digital converter connected between the controller and the at least one of the current sensor and the voltage sensor.

66. The system of claim 62, wherein the current sensor comprises a resistor wherein current sensed thereby is based on a voltage drop across the resistor.

67. The system of claim 62, wherein the resistance of the shape memory alloy actuator indicates that the shape of the shape memory alloy actuator completes changing when the resistance starts increasing after decreasing as the power is supplied to the shape memory alloy actuator.

68. The system of claim 62, wherein the controller is further adapted to maintain the reduced power at a level that maintains the resistance where the shape memory alloy actuator completes changing shape.

69. A control system for controlling a shape memory alloy actuator, comprising:
a means for determining a resistance of the shape memory alloy actuator for determining a change in shape of the shape memory alloy actuator as power is supplied to the shape memory actuator; and
a means for stopping or reducing the power supplied to the shape memory alloy actuator when the determined resistance indicates that the shape of the shape memory alloy actuator completes changing.

70. The control system of claim 69, wherein the resistance determining means comprises at least one of a means for measuring current flowing through the shape memory alloy actuator and a means for measuring a voltage drop across the shape memory alloy actuator.

71. The control system of claim 69, wherein the resistance of the shape memory alloy actuator indicates that the shape of the shape memory alloy actuator completes changing when the resistance starts increasing after decreasing as the power is supplied to the shape memory alloy actuator.

72. The control system of claim 69 further comprising a means for maintaining the reduced power at a level where the resistance is where the shape memory alloy actuator completes changing shape.

73. A computer-usable media containing computer-readable instructions for causing a controller to perform a method comprising:
determining when a shape memory alloy completes changing shape based on measurements of a resistance of the shape memory alloy; and
reducing power supplied to the shape memory alloy after the determining.

74. The computer-usable media of claim 73, wherein, in the method, determining the resistance of the shape memory alloy comprises measuring at least one of a current flowing through the shape memory alloy and a voltage drop across the shape memory alloy.

75. The computer-usable media of claim 73, wherein, in the method, determining when the shape memory alloy completes changing shape based on measurements of a resistance of the shape memory alloy comprises determining when the resistance of the shape memory alloy starts increasing after decreasing.

76. The computer-usable media of claim 73, wherein, in the method, reducing the power supplied to the shape memory alloy comprises reducing the power to a level that maintains the shape memory alloy where the changing shape is complete.

77. The computer-usable media of claim 73, wherein the method further comprises before determining when the shape memory alloy completes changing shape, maintaining the power at a level where the resistance of the shape memory alloy has decreased after increasing.

78. The computer-usable media of claim 73, wherein, in the method, reducing the power supplied to the shape memory alloy comprises stopping the power supplied to the shape memory alloy.
